(19) United States
(12) Patent Application Publication
(10) Pub. No.: US 2024/0012873 A1
(43) Pub. Date: Jan. 11, 2024

(54) ELECTRONIC DEVICE AND METHOD FOR ACCELERATING CANONICAL POLYADIC DECOMPOSITION

(71) Applicant: Industrial Technology Research Institute, Hsinchu (TW)

(72) Inventors: Chia-Hsiang Yang, Kinmen County (TW); Chen-Chien Kao, Taipei City (TW); Chao-Hung Chen, Tainan City (TW)

(73) Assignee: Industrial Technology Research Institute, Hsinchu (TW)

(21) Appl. No.: 18/077,126

(22) Filed: Dec. 7, 2022

Related U.S. Application Data
(60) Provisional application No. 63/358,870, filed on Jul. 7, 2022.

(30) Foreign Application Priority Data
Sep. 14, 2022 (TW) 111134795

(51) Int. Cl. G06F 17/16; G06F 17/14

(52) U.S. Cl. CPC G06F 17/16; G06F 17/145; G06F 17/147

(57) ABSTRACT

An electronic device and a method for accelerating canonical polyadic (CP) decomposition are provided. The method includes: performing at least one of a Walsh-Hadamard transform (WHT) operation and a discrete cosine transform (DCT) operation on a first factor matrix, a second factor matrix, and a tensor respectively to update the first factor matrix, the second factor matrix and the tensor; sampling the updated first factor matrix and the updated second factor matrix to generate a first sampled matrix, and sampling an unfolded matrix of the updated tensor to generate a second sampled matrix; solving a least square problem of the first sampled matrix and the second sampled matrix to generate or update a third factor matrix of the tensor so as to update multiple components of the tensor; and outputting multiple components after an updating of multiple components is finished.

### CROSS-REFERENCE TO RELATED APPLICATION

This application claims the priority benefits of U.S. provisional application Ser. No. 63/358,870, filed on Jul. 7, 2022, and Taiwanese application serial no. 111134795, filed on Sep. 14, 2022. The entirety of each of the above-mentioned patent applications is hereby incorporated by reference herein and made a part of this specification.

### TECHNICAL FIELD

The present disclosure relates to an electronic device and a method for accelerating canonical polyadic (CP) decomposition.

### BACKGROUND

Tensors can be viewed as matrices of order 3 or higher (r≥3). CP decomposition is a common tensor decomposition method, which is commonly adopted in deep learning, communication signal analysis or hyperspectral image processing and other fields. CP decomposition decomposes a tensor into multiple components. The alternating least squares (ALS) algorithm is a CP decomposition algorithm that optimizes each component of a tensor in sequence to reduce the error of each component. However, the execution of ALS algorithm consumes a lot of computing resources. Therefore, how to reduce the computing resources consumed in executing the ALS algorithm is one of the important issues in the field.

### SUMMARY

The present disclosure provides an electronic device and a method for accelerating CP decomposition, which is able to reduce computing resources, time or memory capacity required for CP decomposition.

An electronic device for accelerating canonical polyadic decomposition of the present disclosure is adaptable for updating multiple components of a tensor, and the multiple components include a first factor matrix corresponding to a first dimension and a second factor matrix corresponding to a second dimension. The electronic device includes a mix engine circuit, a processor, and a least square solver circuit. The mix engine circuit performs at least one of a Walsh-Hadamard transform (WHT) operation and a discrete cosine transform (DCT) operation on the first factor matrix, the second factor matrix, and the tensor, respectively, to update the first factor matrix, the second factor matrix, and the tensor. The processor is coupled to the mix engine circuit, and the processor samples the updated first factor matrix and the updated second factor matrix to generate the first sampled matrix, and samples an unfolded matrix of the updated tensor to generate the second sampled matrix. The unfolded matrix corresponds to the third dimension. The least square solver circuit is coupled to the processor, and the least square solver circuit solves a least square problem corresponding to the first sampled matrix and the second sampled matrix to generate or update a third factor matrix of the tensor, thereby updating the multiple components. The processor outputs the multiple components after the updating of the multiple components is completed.

In an embodiment of the present disclosure, before performing at least one of the WHT operation and the DCT operation on the first factor matrix, the mix engine circuit randomly performs sign inversion on the first row vector of the first factor matrix.

In an embodiment of the present disclosure, the mix engine circuit obtains a column vector from the first factor matrix, and performs the WHT operation on the column vector in response to the length of the column vector being the product of a power of two and a positive integer.

In an embodiment of the present disclosure, in response to the positive integer greater than one, the mix engine circuit performs the DCT operation on the column vector after performing the WHT operation on the column vector.

In an embodiment of the present disclosure, the mix engine circuit obtains a column vector from the first factor matrix, and performs the DCT operation on the column vector in response to the length of the column vector not being a product of a power of two and a positive integer.

In an embodiment of the present disclosure, the mix engine circuit obtains a sub-vector whose length is equal to a power of two from the column vector, and performs the WHT operation on the sub-vector.

In an embodiment of the present disclosure, the mix engine circuit performs the DCT operation on the column vector according to an interval of the power of two.

In an embodiment of the present disclosure, the electronic device further includes an index sampler. The index sampler generates a random index collection, and the random index collection includes a first random index corresponding to the first dimension and a second random index corresponding to the second dimension. The processor obtains the first vector from the updated first factor matrix according to the first random index, and obtains the second vector from the updated second factor matrix according to the second random index. The processor calculates the matrixed tensor times Khatri-Rao product of the first vector and the second vector to generate the first sampled matrix.

In an embodiment of the present disclosure, the processor obtains the third vector from the unfolded matrix according to the first random index and the second random index to generate the second sampled matrix.

In an embodiment of the present disclosure, after solving the least square problem to generate or update the third factor matrix, the mix engine circuit performs at least one of an inverse WHT operation and an inverse DCT operation on the first factor matrix, thereby updating the multiple components.

In an embodiment of the present disclosure, after performing at least one of inverse WHT operation and inverse DCT operation on the first factor matrix, the mix engine circuit performs sign inversion on the first row vector of the first factor matrix again.

In an embodiment of the present disclosure, the mix engine circuit performs at least one of inverse WHT operation and inverse DCT operation on the first factor matrix in response to the number of update iterations of the multiple components reaching a threshold.

In an embodiment of the present disclosure, after solving the least square problem to generate or update the third factor matrix, the mix engine circuit, the processor, and the least square solver circuit update the second factor matrix according to the third factor matrix and the first factor matrix, thereby updating the multiple components.

In an embodiment of the present disclosure, the electronic device further includes a normalizer circuit. The normalizer circuit is coupled to the least square circuit, and after solving the least square problem, performs normalization on the third factor matrix. The normalization includes: calculating a norm of a vector of the third factor matrix; calculating a reciprocal of the norm; and calculating a product of the reciprocal and a vector.

A method for accelerating a canonical polyadic decomposition of the present disclosure is adaptable for updating multiple components of a tensor, and the multiple components include a first factor matrix corresponding to a first dimension and a second factor matrix corresponding to a second dimension. The method includes: performing at least one of a WHT operation and a DCT operation on the first factor matrix, the second factor matrix, and the tensor, respectively, to update the first factor matrix, the second factor matrix, and the tensor; sampling the updated first factor matrix and the updated second factor matrix to generate the first sampled matrix, and sampling an unfolded matrix of the updated tensor to generate the second sampled matrix, and the unfolded matrix corresponds to the third dimension; solving a least square problem corresponding to the first sampled matrix and the second sampled matrix to generate or update a third factor matrix of the tensor, thereby updating the multiple components; and outputting the multiple components after the updating of the multiple components is completed.

Based on the above, the electronic device of the present disclosure is able to perform special preprocessing such as sign inversion, WHT operation or DCT operation on the tensor (or a factor matrix thereof) before CP decomposition processing, and is able to perform CP decomposition in a random sampling manner, thereby reducing the time it takes to perform CP decomposition of tensors.

### BRIEF DESCRIPTION OF THE DRAWINGS

FIG. 1 is a schematic diagram illustrating the execution of an ALS algorithm.

FIG. 2 is a schematic diagram of an electronic device for accelerating CP decomposition according to an embodiment of the present disclosure.

FIG. 3 is a schematic diagram illustrating the execution of an alternating least squares algorithm based on random sampling according to an embodiment of the present disclosure.

FIG. 4A illustrates a flowchart of a method for accelerating CP decomposition according to an embodiment of the present disclosure.

FIG. 4B illustrates a detailed flowchart of step S430 according to an embodiment of the present disclosure.

FIG. 5 illustrates a schematic diagram of performing sign inversion on the matrix Y according to an embodiment of the present disclosure.

FIG. 6 shows a schematic diagram of obtaining a vector from the matrix Y according to an embodiment of the present disclosure.

FIG. 7 is a schematic diagram illustrating the execution of Walsh-Hadamard transform (WHT) operation according to an embodiment of the present disclosure.

FIG. 8 is a schematic diagram illustrating the execution of discrete cosine transform (DCT) operation according to an embodiment of the present disclosure.

FIG. 9 is a flowchart illustrating a method for accelerating CP decomposition according to an embodiment of the present disclosure.

### DETAILED DESCRIPTION OF DISCLOSED EMBODIMENTS

CP decomposition is a common tensor decomposition method, which is able to convert a tensor X into the form shown in equation (1), where X(a₁, a₂, . . . , a_{N}) is an element in the tensor X, and aₙ is an index corresponding to the n-th dimension, r is the rank of the tensor X, the positive integer R is the maximum value of r, Aₙ(aₙ, r) is an element corresponding to rank r and index aₙ in the factor matrix Aₙ corresponding to the n-th dimension, the positive integer N is a total dimension, the positive integer n is the index of the factor matrix (1≤n≤N), and λ(r) is the coefficient corresponding to the rank r of the tensor X. The multiple components of the tensor X may include N two-dimensional matrices such as factor matrices A₁, A₂, . . . , A_{N}.

X(a₁,a₂, . . . ,a_{N})=Σᵣ₌₁^{R}λ(r)·A|(a₁,r)·A₂(a₂,r)· . . . ·A_{N}(a_{N},r) (1)

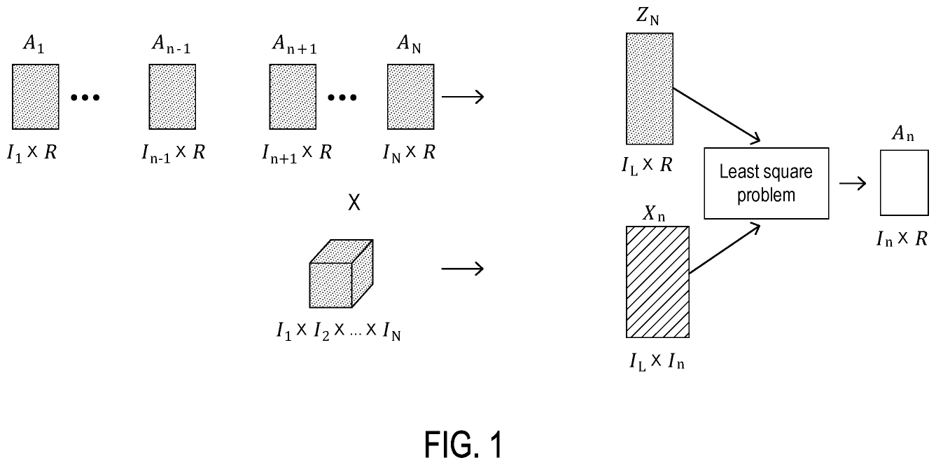

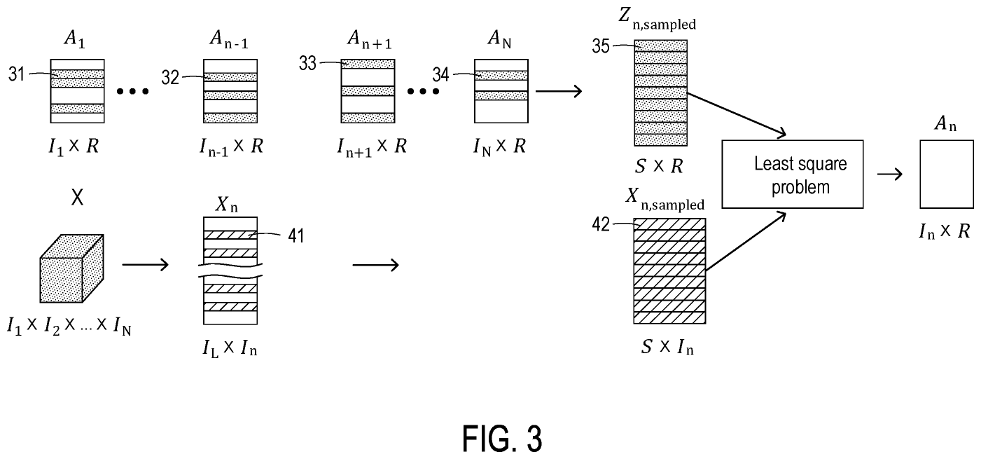

The Alternating Least Squares (ALS) algorithm may be used to update or correct the factor matrix of the tensor X. FIG. 1 shows a schematic diagram of the execution of the ALS algorithm. Suppose an N-dimensional tensor X has a size of I₁×I₂× . . . ×I_{N}. In order to optimize the factor matrix Aₙ having a size of Iₙ×R of the tensor X in the n-th dimension, the ALS algorithm may calculate the matrix Zₙ(I_{L}=Π_{m=1,m≠n}^{N}Iₘ) having a size of I_{L}×R according to equation (2); the size of the factor matrix A₁ is I₁×R, the size of the factor matrix Aₙ₋₁ is Iₙ₋₁×R, the size of the factor matrix Aₙ₊₁ is Iₙ₊₁×R, the size of the factor matrix A_{N} is I_{N}×R, and the operator ⊙ represents the matrixed tensor times Khatri-Rao product (MTTKPP) operation. FIG. 1 and FIG. 3 illustrate the condition where 1<n<N, but the index n may also be equal to 1 or equal to N.

$${Z}_{n} = \{ \begin{matrix}{A}_{N} ⊙ {A}_{N - 1} ⊙ … ⊙ {A}_{n + 1} ⊙ {A}_{n - 1} ⊙ … ⊙ {A}_{1} , & 1 < n < N \\ {A}_{N - 1} ⊙ {A}_{N - 2} ⊙ … ⊙ {A}_{1 ,} & n = N \\ {A}_{N} ⊙ {A}_{N - 1} ⊙ … ⊙ {A}_{2 ,} & n = 1\end{matrix} \qquad ( 2 )$$

The ALS algorithm may also perform mode-n unfolding on the tensor X to obtain a two-dimensional unfolded matrix Xₙ, as shown in equation (3); Xₙ(j, iₙ) is an element in the unfolded matrix Xₙ, and X(i₁, i₂, . . . , i_{N}) is an element in the tensor X. The size of the unfolded matrix Xₙ is I_{L}×Iₙ, and I_{L}=Π_{m=1,m≠n}^{N}Iₘ.

$$\{ \begin{matrix}{X}_{n} ( j , {i}_{n} ) = X ( {i}_{1} , {i}_{2} … , {i}_{N} ) \\ j = 1 + {\sum }_{k = 1 , k \neq n}^{N} ( {i}_{k} - 1 ) \cdot {J}_{K} \\ {J}_{K} = {\prod }_{m = 1 , m \neq n}^{k - 1} {I}_{m}\end{matrix} \qquad ( 3 )$$

After obtaining the matrix Zₙ and the unfolded matrix Xₙ, the ALS algorithm may obtain the factor matrix Aₙ by solving the least square problem of the matrix Zₙ and the unfolded matrix Xₙ as shown in equation (4). The solving process of the least square problem shown in equation (4) needs to calculate Zₙ^{T}·Xₙ, so it is required to consume a lot of computing resources in the multiplication operation.

$${A}_{n} ← arg {min}_{{A}_{n}} {‖ {X}_{n} - {Z}_{n} \cdot {A}_{n}^{T} ‖}_{F}^{2} \qquad ( 4 )$$

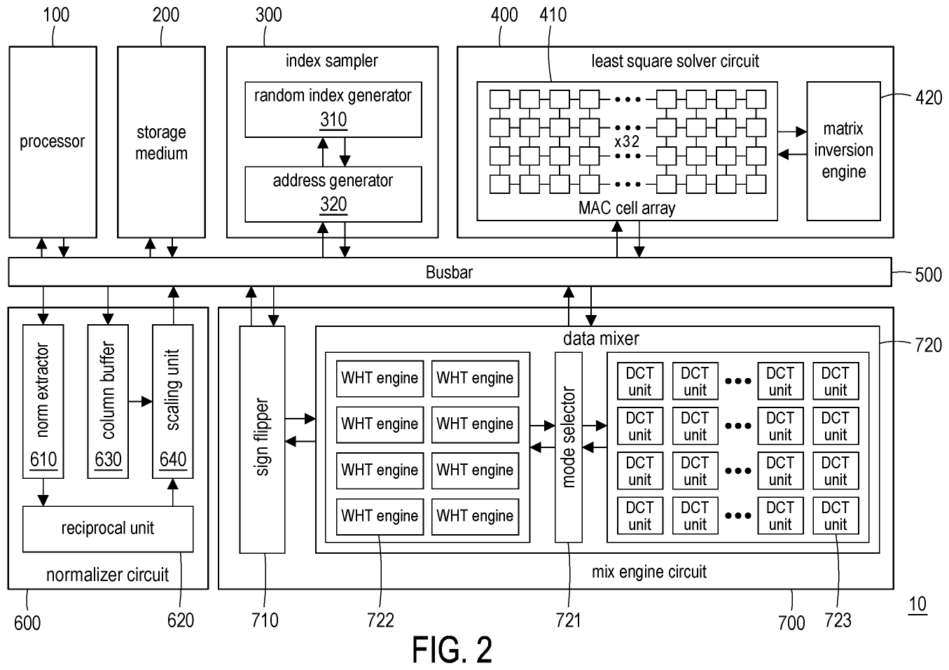

In view of this, the present disclosure provides an electronic device based on random sampling, which is able to significantly reduce the computing resources consumed for performing CP decomposition. FIG. 2 is a schematic diagram of an electronic device 10 for accelerating CP decomposition according to an embodiment of the present disclosure. The electronic device 10 may include a processor 100, a storage medium 200, an index sampler 300, a least square solver (or LS solver) circuit 400, a busbar 500, a normalizer circuit 600, a mix engine circuit 700 and so on, and various circuits may be electrically connected to each other through the busbar 500.

The processor 100 is, for example, a central processing unit (CPU), or other programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable logic gate array (FPGA) or other similar elements or a combination of the above elements.

The storage medium 200 is, for example, any type of fixed or removable random access memory (RAM), a read-only memory (ROM), a flash memory, a hard disk drive (HDD), a solid state drive (SSD), or similar elements or a combination of the above elements. The storage medium 200 may be adopted to store the operation results generated in each step in the CP decomposition process.

The index sampler 300 may include a random index generator 310 and an address generator 320. The random index generator 310 may be electrically connected to the address generator 320, and the address generator 320 may be electrically connected to the busbar 500. After the random index generator 310 generates the index, the address generator 320 may generate corresponding address information according to the index. The address information may be provided to other circuits (e.g., least square solver circuit 400, normalizer circuit 600, or mix engine circuit 700) to obtain the value corresponding to the index from storage medium 200.

The least square solver circuit 400 may include a multiply accumulate (MAC) cell array 410 and a matrix inversion engine 420. The matrix inversion engine 420 may be electrically connected to the MAC cell array 410, and the MAC cell array 410 may be electrically connected to the busbar 500. The MAC cell array 410 may include multiple MAC cells.

The normalizer circuit 600 may include a norm extractor 610, a reciprocal unit 620, a column buffer 630, and a scaling unit 640. The reciprocal unit 620 may be electrically connected to the norm extractor 610 and the scaling unit 640. The scaling unit 640 may be electrically connected to the column buffer 630. The norm extractor 610, the column buffer 630 and the scaling unit 640 may be electrically connected to the busbar 500.

The mix engine circuit 700 may include a sign flipper 710 and a data mixer 720. The sign flipper 710 may be electrically connected to the data mixer 720, and the sign flipper 710 and the data mixer 720 may be electrically connected to the busbar 500. The data mixer 720 may include a mode selector 721, one or more Walsh-Hadamard transform (WHT) engines 722, and one or more discrete cosine transform (DCT) units 723. The mode selector 721 may be electrically connected to the WHT engine 722 and the DCT engine 723.

FIG. 3 is a schematic diagram illustrating the execution of an alternating least squares algorithm based on random sampling according to an embodiment of the present disclosure. To update or correct the factor matrix Aₙ, the electronic device 10 may execute an ALS algorithm. In the process of executing the ALS algorithm, the electronic device 10 may perform random sampling on the tensor X or other factor matrices of the tensor X (e.g., factor matrices A₁, Aₙ₋₁, Aₙ₊₁, . . . , A_{N}) to obtain a sampled matrix X_{n,sampled} and a sampled matrix Z_{n,sampled} respectively, and the sampled matrix X_{n,sampled} may be of size S×Iₙ, and the sampled matrix Z_{n,sampled} may be of size S×R, where 1<S≤I_L. The least square solver circuit 400 may solve a least square problem corresponding to the sampled matrices X_{n,sampled} and Z_{n,sampled} to derive the factor matrix Aₙ. When S<<I_{L}, the computing resources required to solve the least square problem may be significantly reduced.

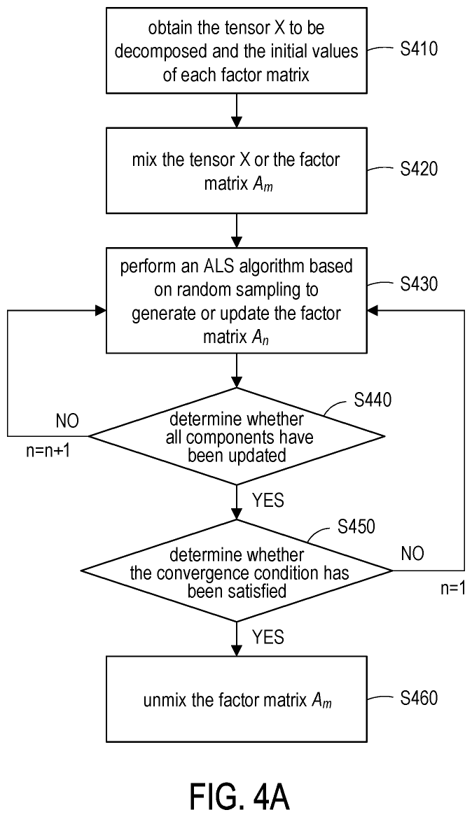

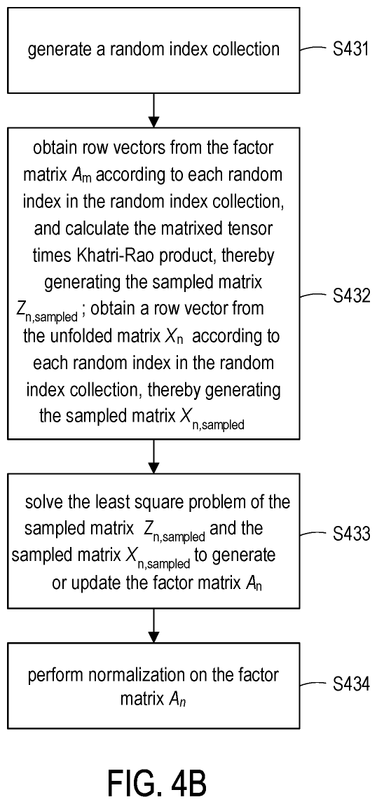

FIG. 4A illustrates a flowchart of a method for accelerating CP decomposition according to an embodiment of the present disclosure. The method of FIG. 4A is adopted to update multiple components of the tensor X, and the multiple components include factor matrices A₁, A₂, . . . , A_{N}. In this embodiment, it is assumed that the factor matrix of the first tensor X to be generated or updated is a factor matrix Aₙ corresponding to the n-th dimension, where n is a positive integer and 1≤n≤N.

In step S410, the processor 100 may obtain the tensor X to be decomposed and the initial values of the factor matrix of the tensor X in various dimensions. Assuming that the dimension of the tensor is N, the processor 100 may obtain initial values of N factor matrices such as factor matrices A₁, A₂, . . . , A_{N}. The above-mentioned initial value may be defined by the user, or randomly generated by the processor 100, and the present disclosure is not limited thereto.

In an embodiment, since the ALS algorithm generates or updates one factor matrix with N−1 factor matrices of the tensor X, the processor 100 may only obtain the initial values of the N−1 factor matrices. For example, assuming that the first factor matrix to be generated or updated is the factor matrix Aₙ, the processor 100 may only obtain initial values of N−1 factor matrices (e.g., the factor matrix Aₘ, where 1≤m≤N and m≠n) without the need to obtain the initial value of the factor matrix Aₙ.

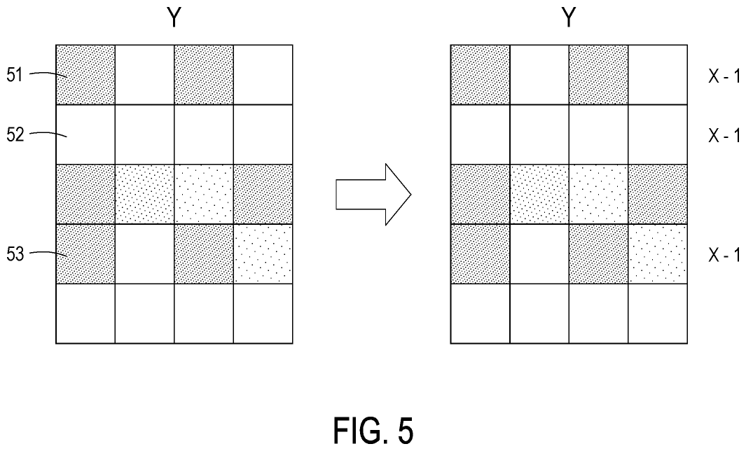

In step S420, the mix engine circuit 700 may mix the tensor X or the factor matrix Aₘ (1≤m≤N, m≠n), thereby updating the tensor X or the factor matrix Aₘ. Specifically, the mix engine circuit 700 may perform sign inversion, WHT operation, or DCT operation on the tensor X or factor matrix Aₘ to mix the tensor X or factor matrix Aₘ. In an embodiment, the mix engine circuit 700 may perform sign inversion on all dimensions (i.e., dimension 1 to dimension N) of the tensor X. The mix engine circuit 700 may perform sign inversion on dimension 1, dimension 2, . . . , dimension N of the tensor X in sequence. First, in order to perform sign inversion on dimension 1 of tensor X, the mix engine circuit 700 may perform mode-1 unfolding on the tensor X to obtain the unfolded matrix X₁, and perform the sign inversion on the transpose matrix X₁^{T} of the unfolded matrix X₁ as shown in FIG. 5, thereby updating the unfolded matrix X₁. Next, the mix engine circuit 700 may perform mode-1 folding on the updated unfolded matrix X₁, thereby obtaining an updated tensor X of dimension 1. Then, in order to perform sign inversion on dimension 2 of the tensor X, the mix engine circuit 700 may perform mode-2 unfolding on the updated tensor X of dimension 1 to obtain an unfolded matrix X₂, and perform the sign inversion on the transpose matrix X₂^{T} of the unfolded matrix X₂ as shown in FIG. 5, thereby updating the unfolded matrix X₂. Next, the mix engine circuit 700 may perform mode-2 folding on the updated unfolded matrix X₂, thereby obtaining an updated tensor X of dimension 2. By analogy, the mix engine circuit 700 may perform sign inversion on the tensor X for N times, thereby updating the tensor X.

FIG. 5 illustrates a schematic diagram of performing sign inversion on the matrix Y according to an embodiment of the present disclosure, and the matrix Y may be a transpose matrix Xᵢ^{T} of the unfolded matrix Xᵢ or the factor matrix Aᵢ (1≤i≤N). The sign flipper 710 in the mix engine circuit 700 may perform sign inversion on a particular row vector of the matrix Y at random, i.e., multiply the particular row vector in the matrix Y by “−1”. In an embodiment, the probability that each row vector of the matrix Y is subjected to sign inversion may be 50%.

The mix engine circuit 700 may record the row index of the row vector in the matrix Y subjected to sign inversion in the storage medium 200. For example, assume that the matrix Y is the factor matrix Aᵢ corresponding to the i-th dimension. If the sign flipper 710 performs sign inversion on the first row (i.e.: row vector 51), the second row (i.e.: row vector 52), and the fourth row (i.e.: row vector 53) of the factor matrix Aᵢ, the mix engine circuit 700 may record the row index [1 2 4] of the factor matrix Aᵢ in the storage medium 200.

In an embodiment, the sign flipper 710 may perform sign inversion on the factor matrix Aᵢ and the transpose matrix XT of the unfolded matrix Xᵢ according to the same row index, thereby updating the factor matrix Aᵢ or the tensor X. Since the total number of rows (i.e.: Iᵢ) of the transpose matrix Xᵢ^{T} is the same as the total number of rows of the factor matrix Aᵢ (i.e.: Iᵢ), the sign flipper 710 may perform sign inversion on the transpose matrix Xᵢ^{T} according to the row index of the factor matrix Aᵢ. For example, assuming that the row index of the factor matrix Aᵢ is [1 2 4], that is, the sign flipper 710 may perform sign inversion on the first row (i.e.: row vector 51), the second row (i.e.: row vector 52) and the fourth row (i.e.: row vector 53) of the factor matrix Aᵢ. Accordingly, the sign flipper 710 may obtain the row index [1 2 4] of the factor matrix Aᵢ from the storage medium 200, and perform sign inversion on the first row, the second row and the fourth row of the transpose matrix XT according to the row index [1 2 4].

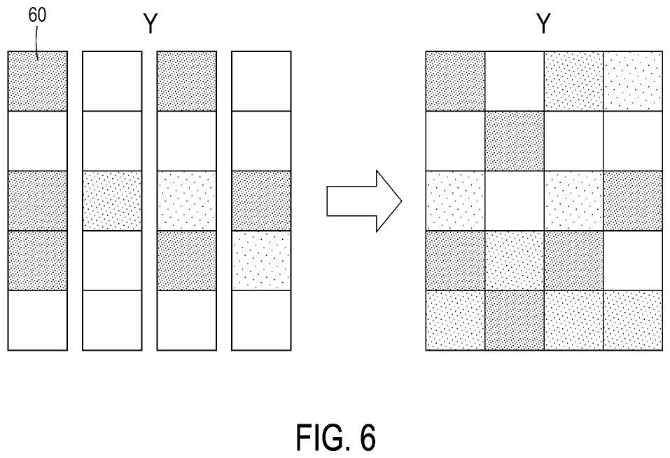

After completing sign inversion on the tensor X or the factor matrix Aₘ, the mix engine circuit 700 may extract the vector from the unfolded matrix Xᵢ, of the tensor X or the factor matrix A m to perform at least one of WHT operation or DCT operation, thereby updating the tensor X or the factor matrix Aₘ. FIG. 6 shows a schematic diagram of obtaining a vector from the matrix Y according to an embodiment of the present disclosure, and the matrix Y is, for example, a transpose matrix Xₙ^{T} of an unfolded matrix Xₙ of a tensor X subjected to sign inversion, or a factor matrix A m subjected to sign inversion. The data mixer 720 of the mix engine circuit 700 may extract each column vector from the matrix Y and perform WHT operation or DCT operation on each column vector. For example, the data mixer 720 may extract column vector 60 from the matrix Y and perform WHT operation or DCT operation on the column vector 60.

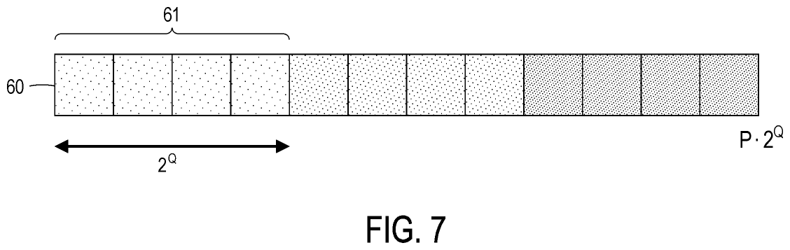

Specifically, the mode selector 721 of the data mixer 720 may determine whether to perform WHT operation or DCT operation on the column vector 60 according to the length of the column vector 60. If the length of the column vector 60 is P·2^{Q} (that is, the length is the product of the Q-th power of 2 and the positive integer P, where Q is a positive integer), the mode selector 721 may instruct one or more WHT engines 722 to perform WHT operation on the column vector 60. FIG. 7 is a schematic diagram illustrating the execution of WHT operation according to an embodiment of the present disclosure. The WHT engine 722 may extract the sub-vector 61 with a length equal to 2^{Q} from the column vector 60 in sequence, and perform the WHT operation on the sub-vector 61.

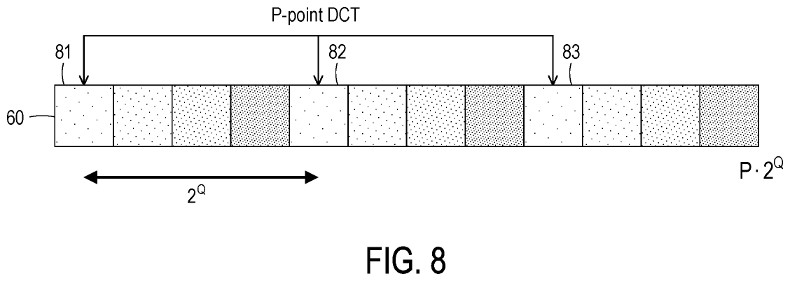

If the positive integer P is greater than 1 (i.e.: the length of the column vector 60≠2^{Q}), after performing the WHT operation on each sub-vector of the column vector 60 the mode selector 721 may instruct one or more DCT units 723 to perform DCT operation on the column vector 60. FIG. 8 is a schematic diagram illustrating the execution of DCT operation according to an embodiment of the present disclosure. The DCT unit 723 may perform P-point DCT operation on the column vector 60 according to an interval of 2^{Q}. In FIG. 8, it is assumed that P is equal to 3 and Q is equal to 2, so the DCT unit 723 may extract 3 elements such as element 81, element 82 and element 83 from the column vector 60 at an interval of 4, and perform 3-point DCT operation on the 3 elements.

On the other hand, if the length of the column vector 60 is not P·2^{Q} (that is, the length is not the product of the Q-th power of 2 and the positive integer P, where Q is a positive integer), the mode selector 721 instructs the DCT unit 723 to perform a multipoint DCT operation on the column vector 60 according to any intervals. The WHT operation will not be performed on the column vector 60. After performing sign inversion, WHT operation or DCT operation on the unfolded matrix Xₙ, the mix engine circuit 700 may perform mode-n folding on the unfolded matrix Xₙ to restore the unfolded matrix Xₙ into a tensor X, where the n-th dimension of the tensor X has been updated.

The conventional CP decomposition method adopts fast Fourier transform (FFT) to mix the unfolded matrix Xₙ of the tensor X or the factor matrix Aₘ. However, the FFT operation has high computational complexity because it involves operation of complex numbers. The present disclosure adopts the WHT operation or the DCT operation to replace conventional FFT operation. Since the WHT operation or the DCT operation only involves operation of real numbers, the present disclosure may considerably reduce multiplication operations for CP decomposition, and reduce the imaginary number information required to be stored in the memory of the computing device (e.g., the storage medium 200).

Returning to FIG. 4A, in step S430, the electronic device 10 may perform an ALS algorithm based on random sampling to generate or update the factor matrix A n according to the factor matrix Aₘ and the unfolded matrix Xₙ. Specifically, the processor 100 may sample the updated factor matrix Aₘ (1≤m≤N, m≠n) to generate the sampled matrix Z_{n,sampled}, and may sample the unfolded matrix Xₙ of the updated tensor X to generate the sampled matrix X_{n,sampled} The least square solver circuit 400 may solve the least square problem corresponding to the sampled matrix Z_{n,sampled} and the sampled matrix X_{n,sampled} to generate or update the factor matrix Aₙ, as shown in FIG. 3.

FIG. 4B shows a detailed flowchart of step S430 according to an embodiment of the present disclosure. In step S431, the random index generator 310 may generate a random index collection, and the random index collection includes N−1 random indices corresponding to N−1 dimensions respectively. The N−1 random indices include random indices i(m) (1≤i(m)≤Iₘ, where Iₘ is the total number of rows of the factor matrix Aₘ) corresponding to the m-th dimension (1≤m≤N, m≠n). For example, the random index generator 310 may generate a random index collection [i(1) . . . i(n−1)i(n+1) . . . i(N)], where the random index i(1) corresponds to the 1st dimension, i(n−1) corresponds to the n−1-th dimension, i(n+1) corresponds to the n+1-th dimension, and i(N) corresponds to the N-th dimension. The random index generator 310 may generate S random index collections (1<S≤I_{L}, where S is a positive integer, and I_{L}=Π_{m=1,m≠n}^{N}Iₘ).

In step S432, the processor 100 may obtain row vectors from the factor matrix Aₘ according to each random index in the random index collection, and calculate the matrixed tensor times Khatri-Rao product (MTTKPP) according to each row vector based on equation (5), thereby generating the sampled matrix Z_{n,sampled} as shown in FIG. 3, where Z_{n,sampled}(k) represents the k-th row (1≤k≤S) of the sampled matrix Z_{n,sampled}, and vi(x) represents the row vector corresponding to the random index i(x) in the factor matrix Aₓ (1≤x≤N, x≠n). Taking FIG. 3 as an example, it is assumed that the random index collection [i(1) i(n−1) i(n+1) i(N)] corresponds to the k-th row (1≤k≤S) of the sampled matrix Z_{n,sampled}, the random index i(1) in the random index collection [i(1) . . . i(n−1) i(n+1) . . . i(N)] corresponds to the row vector 31 of the factor matrix A₁, the random index i(n−1) corresponds to the row vector 32 of the factor matrix Aₙ₋₁, the random index i(n+1) corresponds to the row vector 33 of the factor matrix Aₙ₊₁, and the random index i(N) corresponds to the row vector 34 of the factor matrix A_{N}, then the processor 100 may calculate the matrixed tensor times Khatri-Rao product corresponding to the row vector 31, the row vector 32, the row vector 33 and the row vector 34 according to equation (5), thereby obtaining the row vector 35 of the sampled matrix Z_{n,sampled}.

$${Z}_{n , sampled} ( k ) = \{ \begin{matrix}{v}_{i ( N )} ⊙ … ⊙ {v}_{i ( n + 1 )} ⊙ {v}_{i ( n - 1 )} ⊙ … ⊙ {v}_{i ( 1 ) ,} & 1 < n < N \\ {v}_{i ( N - 1 )} ⊙ {v}_{i ( N - 2 )} ⊙ … ⊙ {v}_{i ( 1 ) ,} & n = N \\ {v}_{i ( N )} ⊙ {v}_{i ( N - 1 )} ⊙ … ⊙ {v}_{i ( 2 ) ,} & n = 1\end{matrix} \qquad ( 5 )$$

On the other hand, the processor 100 may obtain a row vector from the unfolded matrix Xₙ according to each random index in the random index collection, thereby generating the sampled matrix X n,sampled as shown in FIG. 3. Taking FIG. 3 as an example, assume that the random index collection corresponding to the k-th row (1≤k≤S) of the sampled matrix X_{n,sampled} (or Z_{n,sampled}) is [1(1) . . . i(n−1) i(n+1) i(N)], the processor 100 may obtain the row vector 41 corresponding to the random index collection [i(1) i(n−1) i(n+1) i(N)] from the unfolded matrix Xₙ according to the random index collection [i(1) i(n−1) i(n+1) i(N)] as the row vector 42 of the sampled matrix X_{n,sampled} (i.e.: the k-th row of X_{n,sampled}) The j-th element in the row vector 41 may be expressed as Xₙ(i(1), . . . , i(n−1), j, i(n+1), i(N)), where 1≤j≤Iₙ.

After obtaining the sampled matrix Z_{n,sampled} and the sampled matrix X_{n,sampled}, in step S433, the MAC cell array 410 of the least square solver circuit 400 may solve the least square problem of the sampled matrix Z n,sampled and the sampled matrix X_{n,sampled} to generate or update the factor matrix A n as shown in equation (6). The matrix inversion operation used in solving the least square problem may be implemented by the matrix inversion engine 420. Since the dimension of the least square problem shown in equation (6) is much smaller than that of the least square problem shown in equation (4), the computational delay of CP decomposition may be effectively reduced.

$${A}_{n} ← arg {min}_{{A}_{n}} {‖ {X}_{n , sampled} - {Z}_{n , sampled} \cdot {A}_{n}^{T} ‖}_{F}^{2} \qquad ( 6 )$$

In step S434, the normalizer circuit 600 may perform normalization on the factor matrix Aₙ. Specifically, the norm extractor 610 of the normalizer circuit 600 may extract a vector (e.g., any column vector) from the factor matrix Aₙ, and calculate the norm of the vector, where the norm is, for example, L1 norm or L2 norm. The vector may be temporarily stored in the column buffer 630. The reciprocal unit 620 may calculate the reciprocal of the norm. After extracting the norm of the vector in the factor matrix Aₙ, and after extracting the reciprocal of the norm, the scaling unit 640 may set the reciprocal as a scaling value. The scaling unit 640 may calculate the product of the vector in the factor matrix A n and the corresponding scaling value to normalize the factor matrix Aₙ, as shown in equation (7), where cₓ is the x-th column vector of the unnormalized factor matrix Aₙ, and ∥cₓ∥ is the norm of the vector cₓ.

$$Normalized {A}_{n} = [ \frac{{c}_{1}}{‖ {c}_{1} ‖} \frac{{c}_{2}}{‖ {c}_{2} ‖} … \frac{{c}_{R}}{‖ {c}_{R} ‖} ] \qquad ( 7 )$$

Returning to FIG. 4A, after generating or updating the factor matrix Aₙ, in step S440, the processor 100 may determine whether all components of the tensor X (i.e.: factor matrices A₁, A₂, . . . , A_{N}) have been generated or updated. If all components have been generated or updated, go to step S450. If there are still components that have not been generated or updated, the processor 100 may set n=n+1, and execute step S430 again, so as to update the factor matrix Aₙ₊₁ according to the unfolded matrix Xₙ₊₁ of the tensor X and each factor matrix Aₘ (1≤m≤N, m≠(n+1)).

In step S450, the processor 100 may determine whether the convergence condition of the tensor X has been satisfied. If the convergence condition of the tensor X is satisfied, go to step S460. If the convergence condition of the tensor X has not been satisfied, the processor 100 may set n=1, and perform step S430 again.

In an embodiment, the convergence condition of the tensor X is related to the number of update iterations of the components of the tensor X (i.e.: factor matrices A₁, A₂, . . . , or A_{N}). If the number of update iterations of each component of the tensor X reaches a threshold, the processor 100 may determine that the convergence condition of the tensor X has been satisfied. Otherwise, the processor 100 may determine that the convergence condition of the tensor X has not been satisfied. For example, suppose the threshold is 10. The processor 100 may determine that the convergence condition of the tensor X has been satisfied in response to the number of updating of the factor matrix A N reaching 10 times.

In step S460, the mix engine circuit 700 may unmix the factor matrix A m (1≤m≤N, m≠n). After completing the isolation, the processor 100 may output the multiple components of the tensor X (i.e.: factor matrices A₁, A₂, . . . , and A_{N}).

Specifically, the processor 100 may determine whether the mix engine circuit 700 has performed the DCT operation on the factor matrix A m in step S420. If the mix engine circuit 700 has performed a DCT operation on the factor matrix A m, the data mixer 720 may perform an inverse discrete cosine transform (IDCT) operation on the factor matrix Aₘ. The data mixer 720 may extract the column vector from the factor matrix Aₘ and perform an IDCT operation on the column vector. If the length of the column vector is P·2^{Q} (that is, the length is the product of the Q-th power of 2 and the positive integer P, where Q is a positive integer and P>1), the DCT unit 723 may perform a P-point IDCT operation on the column vector according to the interval of 2^{Q}. If the length of the column vector is not P·2^{Q}, the DCT unit 723 may perform a multi-point IDCT operation on the column vector according to any interval.

If the processor 100 determines that the mix engine circuit 700 has not performed the DCT operation on the factor matrix Aₘ, or the mix engine circuit 700 has completed the above IDCT operation, the processor 100 may further determine whether the mix engine circuit 700 has performed the WHT operation on the factor matrix A m in step S420. If the mix engine circuit 700 has performed the WHT operation on the factor matrix Aₘ, the data mixer 720 may perform an inverse Walsh-Hadamard transform (IWHT) operation on the factor matrix Aₘ. The WHT engine 722 may extract sub-vectors with a length equal to 2^{Q} from the column vector of the factor matrix Aₘ, and perform an IWHT operation on the sub-vectors.

If the processor 100 determines that the mix engine circuit 700 has not performed the WHT operation on the factor matrix Aₘ, or the mix engine circuit 700 has completed the IWHT operation, the processor 100 may further determine whether the mix engine circuit 700 has performed sign inversion on a specific row vector of the factor matrix Aₘ in step S420. If the mix engine circuit 700 has performed sign inversion on a specific row vector of the factor matrix Aₘ in step S420, the sign flipper 710 may perform a sign inversion on the specific row vector again, and the implementation of sign inversion is the same as that of the embodiment in FIG. 5, so the details are not repeated here. For example, it is assumed that the mix engine circuit 700 has performed sign inversion on the first row (i.e.: row vector 51), the second row (i.e.: row vector 52) and the fourth row (i.e.: row vector 53) of the factor matrix Aᵢ in step S420. Accordingly, the sign flipper 710 may read the row index [1 2 4] of the factor matrix Aᵢ from the storage medium 200, and perform sign inversion on the first row (i.e.: row vector 51), the second row (i.e.: row vector 52), and the fourth row (i.e.: row vector 53) of the factor matrix Aᵢ according to the row index [1 2 4].

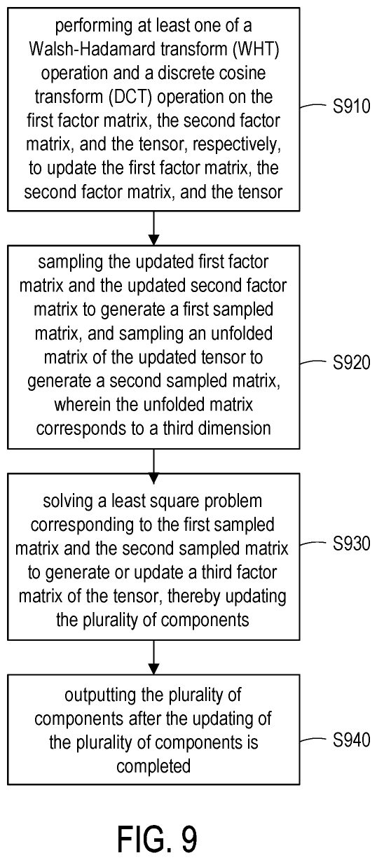

FIG. 9 illustrates a flowchart of a method for accelerating CP decomposition according to an embodiment of the present disclosure, and the method may be implemented by the electronic device 10 shown in FIG. 2. The method is adaptable for updating multiple components of a tensor, and the multiple components include a first factor matrix corresponding to a first dimension and a second factor matrix corresponding to a second dimension. In step S910, at least one of WHT operation and DCT operation is performed on the first factor matrix, the second factor matrix and the tensor respectively to update the first factor matrix, the second factor matrix, and the tensor. In step S920, the updated first factor matrix and the updated second factor matrix are sampled to generate a first sampled matrix, and an unfolded matrix of the updated tensor is sampled to generate a second sampled matrix, and the unfolded matrix corresponds to a third dimension. In step S930, a least square problem corresponding to the first sampled matrix and the second sampled matrix is solved to generate or update a third factor matrix of the tensor, thereby updating multiple components. In step S940, multiple components are output after the updating of the multiple components is completed.

To sum up, the electronic device of the present disclosure is able to perform CP decomposition in a random sampling manner, thereby reducing the computational complexity of performing matrixed tensor times Khatri-Rao product. In order to make the CP decomposition result more accurate, the electronic device may perform preprocessing such as sign inversion, WHT operation or DCT operation on the tensor (or a factor matrix thereof), where the execution of WHT operation or DCT operation may be determined by the electronic device according to the size of the tensor. The present disclosure may considerably reduce computing resources, time or memory capacity required for performing CP decomposition of tensors.

What is claimed is:

1. An electronic device for accelerating a canonical polyadic decomposition (CP decomposition), adaptable for updating a plurality of components of a tensor, wherein the plurality of components comprise a first factor matrix corresponding to a first dimension and a second factor matrix corresponding to a second dimension, wherein the electronic device comprises:
a mix engine circuit, which performs at least one of a Walsh-Hadamard transform (WHT) operation and a discrete cosine transform (DCT) operation on the first factor matrix, the second factor matrix, and the tensor, respectively, to update the first factor matrix, the second factor matrix, and the tensor;
a processor, which is coupled to the mix engine circuit, wherein the processor samples the updated first factor matrix and the updated second factor matrix to generate a first sampled matrix, and samples an unfolded matrix of the updated tensor to generate a second sampled matrix, wherein the unfolded matrix corresponds to a third dimension; and
a least square solver circuit, which is coupled to the processor, wherein the least square solver circuit solves a least square problem corresponding to the first sampled matrix and the second sampled matrix to generate or update a third factor matrix of the tensor, thereby updating the plurality of components, wherein
the processor outputs the plurality of components after the updating of the plurality of components is completed.

2. The electronic device according to claim 1, wherein before performing the at least one of the WHT operation and the DCT operation on the first factor matrix, the mix engine circuit randomly performs a sign inversion on a first row vector of the first factor matrix.

3. The electronic device according to claim 1, wherein the mix engine circuit obtains a column vector from the first factor matrix, and performs the WHT operation on the column vector in response to a length of the column vector being a product of a power of two and a positive integer.

4. The electronic device according to claim 3, wherein in response to the positive integer greater than one, the mix engine circuit performs the DCT operation on the column vector after performing the WHT operation on the column vector.

5. The electronic device according to claim 1, wherein the mix engine circuit obtains a column vector from the first factor matrix, and performs the DCT operation on the column vector in response to a length of the column vector not being a product of a power of two and a positive integer.

6. The electronic device according to claim 3, wherein the mix engine circuit obtains a sub-vector whose length is equal to the power of two from the column vector, and performs the WHT operation on the sub-vector.

7. The electronic device according to claim 4, wherein the mix engine circuit performs the DCT operation on the column vector according to an interval of the power of two.

8. The electronic device according to claim 1, further comprising:
an index sampler, which generates a random index collection, wherein the random index collection comprises a first random index corresponding to the first dimension and a second random index corresponding to the second dimension, wherein
the processor obtains a first vector from the updated first factor matrix according to the first random index, and obtains a second vector from the updated second factor matrix according to the second random index, wherein
the processor calculates a matrixed tensor times Khatri-Rao product of the first vector and the second vector to generate the first sampled matrix.

9. The electronic device according to claim 8, wherein the processor obtains a third vector from the unfolded matrix according to the first random index and the second random index to generate the second sampled matrix.

10. The electronic device according to claim 2, wherein after solving the least square problem to generate or update the third factor matrix, the mix engine circuit performs at least one of an inverse WHT operation and an inverse DCT operation on the first factor matrix, thereby updating the plurality of components.

11. The electronic device according to claim 10, wherein after performing the at least one of the inverse WHT operation and the inverse DCT operation on the first factor matrix, the mix engine circuit performs the sign inversion on the first row vector of the first factor matrix again.

12. The electronic device according to claim 10, wherein the mix engine circuit performs the at least one of the inverse WHT operation and the inverse DCT operation on the first factor matrix in response to the number of update iterations of the plurality of components reaching a threshold.

13. The electronic device according to claim 1, wherein after solving the least square problem to generate or update the third factor matrix, the mix engine circuit, the processor, and the least square solver circuit update the second factor matrix according to the third factor matrix and the first factor matrix, thereby updating the plurality of components.

14. The electronic device according to claim 1, further comprising:
a normalizer circuit, which is coupled to the least square circuit, and after solving the least square problem, performs normalization on the third factor matrix, wherein the normalization comprises:
calculating a norm of a vector of the third factor matrix;
calculating a reciprocal of the norm; and
calculating a product of the reciprocal and the vector.

15. A method for accelerating a canonical polyadic decomposition (CP decomposition), adaptable for updating a plurality of components of a tensor, wherein the plurality of components comprise a first factor matrix corresponding to a first dimension and a second factor matrix corresponding to a second dimension, wherein the method comprises:
performing at least one of a Walsh-Hadamard transform (WHT) operation and a discrete cosine transform (DCT) operation on the first factor matrix, the second factor matrix, and the tensor, respectively, to update the first factor matrix, the second factor matrix, and the tensor;
sampling the updated first factor matrix and the updated second factor matrix to generate a first sampled matrix, and sampling an unfolded matrix of the updated tensor to generate a second sampled matrix, wherein the unfolded matrix corresponds to a third dimension;
solving a least square problem corresponding to the first sampled matrix and the second sampled matrix to generate or update a third factor matrix of the tensor, thereby updating the plurality of components; and
outputting the plurality of components after the updating of the plurality of components is completed.
